(19) United States
(12) Patent Application Publication
(10) Pub. No.: US 2014/0189603 A1
(43) Pub. Date: Jul. 3, 2014

(54) Gesture Based Partition Switching

(71) Applicants: Darryl L. Adams, Portland, OR (US); Jim S. Baca, Corrales, NM (US); Mark H. Price, Pacitas, NM (US)

(72) Inventors: Darryl L. Adams, Portland, OR (US); Jim S. Baca, Corrales, NM (US); Mark H. Price, Pacitas, NM (US)

(21) Appl. No.: 13/729,255

(22) Filed: Dec. 28, 2012

(51) Int. Cl. G06F 3/0484

(52) U.S. Cl. CPC G06F 3/0484
USPC 715/863

(57) ABSTRACT

Generally, a user records one or more user-specific gestures to enable switching from one partition to another using the gesture recorder. Information relating to the recorded gestures is stored in a data storage. Once a user-defined gesture is recorded, a context switcher detects a user performed gesture corresponding to the recorded gesture. Then the context switcher automatically switches from one environment to another environment.

### BACKGROUND

This relates generally to processor-based systems of all types including personal computers and mobile devices.

Corporate or enterprise employees may have plural processor-based devices-at least one for business use and at least another for personal use. Since having two different portable devices tends to be impractical, many employees use their personal processor based devices for business purposes, or their business device for personal use, or both. From the enterprise's position, none of the foregoing options are desirable. Thus, a user, an enterprise, or both may prefer for the user to operate a single portable device that has a blended computing environment with both business and personal capabilities on the same device.

### BRIEF DESCRIPTION OF THE DRAWINGS

Some embodiments are described with respect to the following figures:

FIG. 1 is a schematic block diagram in one embodiment;

FIG. 2 is a schematic depiction of another embodiment;

FIG. 3 is a flow chart for one embodiment;

FIG. 4 is a flow chart for another embodiment; and

FIG. 5 is a block diagram of a system for one embodiment.

### DETAILED DESCRIPTION

In an embodiment, a processor based device includes at least two partitions, each partition corresponding to a different use environment. For example, one user environment may be a personal environment and another environment may be a work environment.

A partition is any logically distinct portion of memory or a storage device that functions as though it were a physically separate unit. Thus, by partitioning the memory either physically or virtually, two different environments may be created. These environments may appear to the user in the form of different displays, and different applications that use different inputs and provide different outputs. In effect from the user's point of view, the user has two equivalent functional devices that are totally separate in many respects.

Other partitions corresponding to other environments may also exist such as a partitioned gaming environment. Other examples of partitioning may be between different users. Thus, each user of the same computer may use a different partition. For example, two employees in the same enterprise may have two different partitioned environments. Within a family, each of the parents may have their own partition on the same computer and each child may have a partition on the same computer. Furthermore, there may be specialized environments corresponding to specific capacities within a particular environment such as different levels of work environments wherein access to each environment may differ such as by security level. These examples of partitions are not meant to be exhaustive and certainly different users can think of enumerable various partitions.

Each partition may exist in memory either as physically different memories and/or virtually different memories such as virtual machines. In this way, each partition is either physically and/or logically separated from the others such that one partition may not know any other partition exists. Each virtual machine may be associated with instances of one or more operating systems and application programs.

Generally, a user records one or more user-specific gestures to enable switching from one partition to another using a gesture recorder. Information relating to the recorded gestures is stored in a data storage. Once a user-defined gesture is recorded, a context switcher detects a user performed gesture corresponding to the recorded gesture. Then the context switcher automatically switches from one environment to another environment.

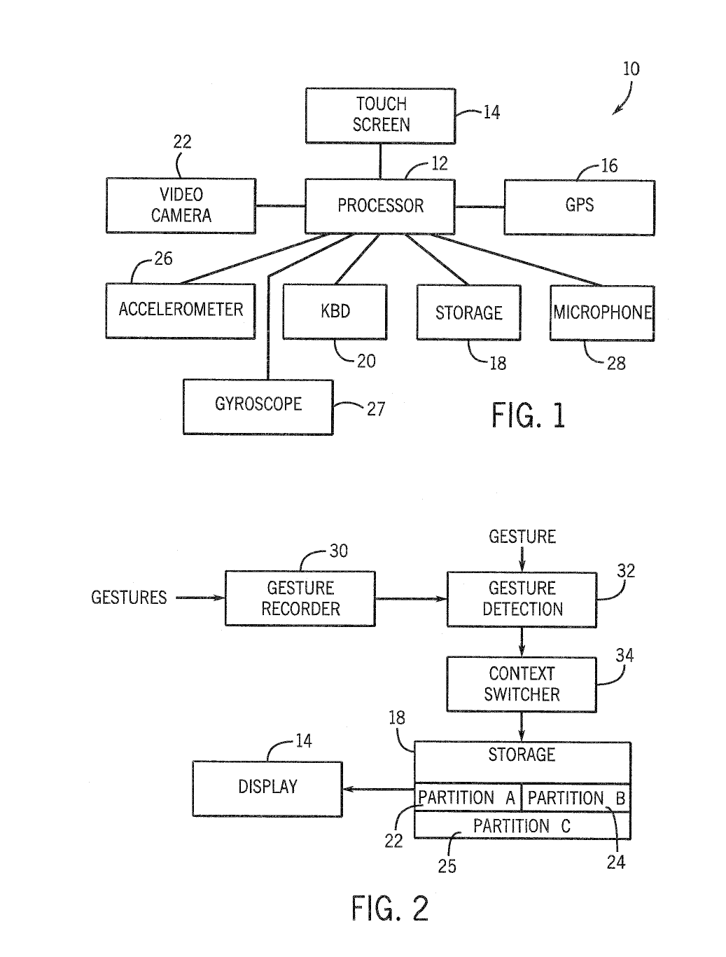

A processor-based device 10, shown in FIG. 1, according to some embodiments may be personal computer, or a mobile computer such as a laptop computer, a mobile Internet device, a cellular telephone, a tablet computer, an e-book reader, a game player, or a media playing device. The device 10 may include a partitioned storage 18 and one or more processors 12 coupled to a display 14 such as a touch screen.

Without limitation, an embodiment may include a display screen such as a resistive touch screen, a capacitive touch screen (e.g., self, mutual, projected), a touch screen that is sensitive to acoustic waves and/or infrared (IR), or a screen with touch sensors. Generally, when a user touches the display screen with one or more fingers information from the touch is sent to the processor for analysis. For example touch information may be analyzed to determine size, shape, location, duration, etc. of the one or more touches. Moreover, the touch information may be interpreted to trigger an event, a command, or both. The operating system, other software (e.g., system software, application software), hardware, and/or firmware may facilitate analyzing touch information, interpreting touch information, triggering events, sending commands, and combinations thereof. In an embodiment, the display screen may also include liquid crystal display (LCD) technology such as thin film transistor (TFT) LCD technology, in-place switching (IPS) LCD technology or organic light emitting diode (OLED) technology including active matrix OLED. In an embodiment the display screen may provide tactile feedback responsive to a touch. However, non-touch screen displays may also be used in some embodiments.

A user may define his or her own custom gesture via the touch screen and/or one or more sensors in some embodiments. For example, the user may touch a capacitive touch screen in a particular way to create a custom touch-based gesture pattern and the device will change from one partition to another if the custom touch-based gesture is later recognized. As another example, the user may move the device in a particular way to create a custom motion based gesture, which is later recognized to switch the device from operating in one partition to another partition. For this purpose, gyroscope 27, accelerometers 26, keyboard 20 or other input devices may be used. In some embodiments other sensor data may be used alone or in conjunction with a gesture to enable switching from one partition to another partition. Other sensor data may be gathered from any sensors on the mobile device such as camera 22, microphone 28, a position sensor such as a global positioning sensor 16. For example, camera image depictions of user motion may be recorded. Then video analytics may be used to identify the depicted gesture, such as a hand or facial gesture.

In an embodiment access to a particular partition may be restricted. For instance access may require a password and/or a condition such proximity to another mobile device, device location, ambient temperature, ambient light and the like. A password and/or environmental condition may be preset when the user initially records his or her customized gesture. In this way, the protected partition cannot be accessed unless the correct password and/or condition is/are met.

A custom gesture may be created using a gesture recorder 30 shown in FIG. 2. The recorder may be software or hardware. The gesture recorder receives a gesture as an input from an input device such as a camera, keyboard, a touch screen, or a global positioning system sensor to mention a few examples. The gesture recorder passes the recorded gesture on to a gesture detection unit 32. The gesture detection unit receives a gesture input, and compares the input to the recorded gesture from the gesture recorder 30. If a match is identified, the gesture detection unit 32 passes a signal to the context switcher 34. The context switcher changes the context from a partition A, indicated at 22 to a partition B indicated at 24 in the storage 18. This may result in a change in the entire display 14 or some part thereof.

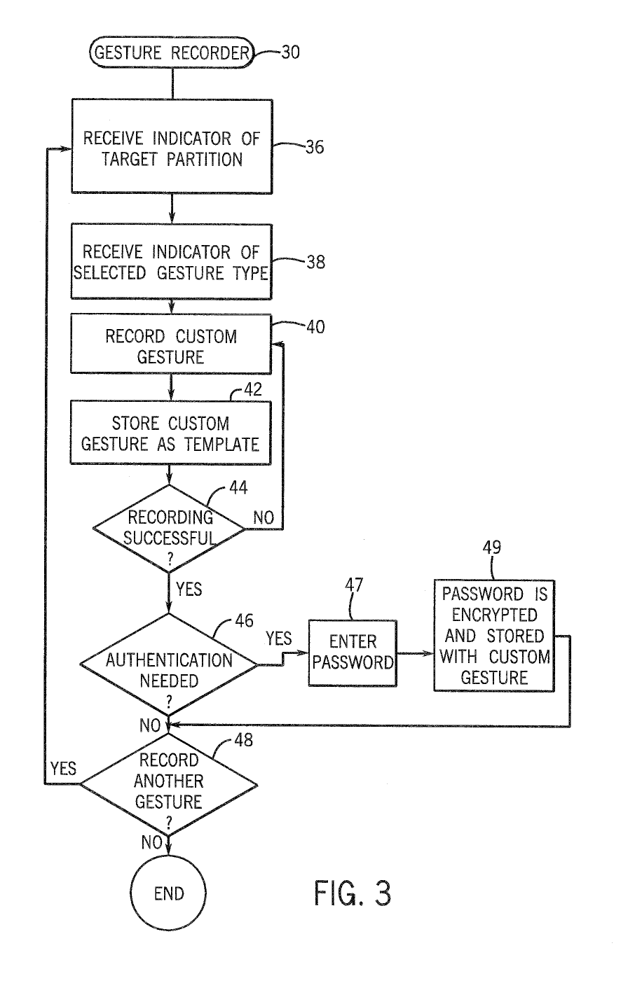

Referring next to FIG. 3, a gesture recorder sequence 30 may be implemented in software, firmware, or hardware. In software and firmware embodiments it may be implemented by computer executed instructions stored in one or more computer readable media such as a non-transitory computer readable media including magnetic, optical or semiconductor storages.

Program code, or instructions, may be stored in, for example, volatile and/or non-volatile memory, such as storage devices and/or an associated machine readable or machine accessible medium including, but not limited to, solid-state memory, hard-drives, floppy-disks, optical storage, tapes, flash memory, memory sticks, digital video disks, digital versatile disks (DVDs), etc., as well as more exotic mediums such as machine-accessible biological state preserving storage. A machine readable medium may include any mechanism for storing, transmitting, or receiving information in a form readable by a machine, and the medium may include amedium through which the program code may pass, such as antennas, optical fibers, communications interfaces, etc. Program code may be transmitted in the form of packets, serial data, parallel data, etc., and may be used in a compressed or encrypted format.

To start the process of creating a custom gesture, the system receives an indicator of a target partition as indicated in block 36. The target partition may be either physically or virtually separated from the other partitions. The indicator may be received via the device 10 such as from a list of available partitions, an entry in a data field, radio button, a voice command, or any other way for a user to communicate with the device 10. Alternatively, the indicator may be received from another device in communication with the device 10.

For example, there are three partitions shown on the mobile device of FIG. 2—partition A, partition B, and partition C. If all three are available, then the user may pick any one of the three partitions to associate with a custom gesture. If any one of the partitions, such as partition C, is not available for linking to a custom gesture, then the user cannot choose partition C as the target partition. A particular partition may not be available for linking a custom gesture if a custom gesture has already been associated with that partition and use of a shared custom gesture is prohibited. Prohibition of a shared custom gesture may be initiated by the user such as via a setting. As an example, the system receives an indicator that partition A is the target partition.

Thereafter, the system receives an indicator (block 38) of the type of gesture to be associated with the selected partition. Gesture types include touch-based gestures, motion-based gestures, or both. Generally, touch-based gestures include any number of swipes, taps, or pinches on a touch screen that is detectable by the touch screen. The swipes, taps, and pinches may occur alone or in combination and in any sequence. Furthermore, the user may use any number or combination of fingers to create the touch-based custom gesture. For example, the touch-based custom gesture may be a letter, number, line, zig-zag, punctuation mark. Morse code, bringing together of certain digits, separating certain digits, bringing together and separating certain digits, and/or any other touch-based gesture thought of by the user and detectable by the touch screen. Motion-based gestures generally include any one or more detectable movements or positions of the device 10. The movements and positions may occur alone or in combination and in any sequence. For example, the motion-based gesture may include tilting, rotating, shaking, waving, or any other motion thought of by the user or designer that is detectable by the device 10.

The system may receive the indicator of gesture type through the device 10 or through a device in communication with the device 10. The indicator may be any indicator such as a selection from list, a radio button, voice command, or data entry into a field, as examples.

In an embodiment, environmental factors may also be associated with the target partition. For example, the target partition may only be accessed if the device 10 is in a particular location, in an environment having a particular temperature or ambient light, within a certain proximity of another pre-determined mobile device, recognizes the features or voice of a particular individual. Restricted access to a particular partition may be for security reasons. For example, if a particular partition should not be accessible when the user is away from a certain location such as the office (or only accessible when at the particular location), then information from a global positioning system (GPS) sensor 16 or other positioning system may be used to determine if the device is at the location. As another example, access to a particular partition may be influenced by the proximity of the device 10 to another device. If the two mobile devices are within a certain range then one or both of the users of the mobile devices may access the restricted partition each respectively on his or her own mobile device.

Context-based input depends upon the sensors that are available in connection with a particular mobile device. The user may be presented with a choice of available contexts based on the available sensors. For example, the user may choose a position-based context, a temperature-based context, a light-based context, a sound-based context, a visual-based context, or any other sensor-dependent context. The mobile device can receive an indicator of context via a list, button, voice command, data entry, or any other way of receiving input from the user. Furthermore, the indicator may be received on a device associated with the mobile device such as a personal computer or different mobile device.

In an embodiment context-based partition access may be useful in a gaming environment. For instance, a particular partition may only be unlocked during a game if the mobile device is in certain lighting conditions, temperature conditions, proximity with different mobile device playing the same game, location, etc. As one example, a scavenger hunt type game may require certain sensed conditions to occur before unlocking or allowing access to a particular partition such as to receive the next clue.

To record the custom gesture, the user performs the custom gesture using the device 10. For example, if the user selected a touch-based gesture, the user touches the touch screen in the desired manner to create the custom gesture. The parameters of the custom gesture are captured and saved. Touch-based gesture parameters include, without limitation, one or more of number, type (e.g. tap, swipe, pinch, pull, and the like), pressure, duration, direction, and location of the one or more touches on the touch screen are captured and recorded by the device. As one non-limiting example, the user may touch the screen in a manner similar to that of an exclamation point.

If the user selected a motion-based gesture, then the user performs the motion using the device 10. For example, the user moves the device 10 or an input device such as a mouse or joy stick in the desired manner to create the custom gesture. The parameters of the movement-based custom gesture are captured by the mobile device using one or more sensors such as an accelerometer or gyroscope. Parameters include, without limitation, number and type of orientation changes, such as one or more of tilting or rotating, direction, and duration.

To make use of a single device for multiple purposes, such as both work and personal, the transition across contexts may be as seamless as possible. To realize the compute-continuum vision, mobile devices need to provide a consistent user experience whether the use is in a business context or a personal context. Mobile device virtualization is an effective way to combine user experiences from both contexts on a single device. Current solutions provide the ability to launch a virtual machine (VM) from within the active operating system. The problem with these solutions is that they either compromise power consumption, security, or usability.

A custom gesture may be created and used to switch between multiple partitions on a device 10. The gesture can be a multi-touch pattern, or a combination of physical movements captured by sensors such as accelerometer and/or gyroscope sensors in the device. Use of the custom gesture to switch contexts also invokes the authentication mechanism. An embodiment includes the creation and use of custom gestures to switch between partitions and invoking the necessary authentication credentials. Although two partitions are discussed, any number of partitions can exist.

The first component is a gesture recorder. The gesture recorder may use capacitive touch screens, and motion sensors such as gyroscopes and accelerometers on mobile devices, as examples. The gesture recorder guides the user through the process of recording a custom gesture. The resulting gesture pattern is stored on the device 10 as a custom template (blocks 40, 42). Then a check at diamond 44 determines whether recording was successful. If so, the flow continues. Otherwise recording is repeated.

In some embodiments, a password protection scheme may also be implemented. In such case, a check at diamond 46 determines whether authentication is required. If so, a password must be entered at block 47. The password is then encrypted and stored with the custom gesture as indicated at block 49.

Next, a check at diamond 48 determines whether it is desired to record another gesture. If so, the flow iterates and otherwise the flow ends.

Application software on the mobile device guides the user through the process of creating the custom gesture. The software prompts the user to repeat the gesture three times in one embodiment. The details of each gesture are recorded and stored on the device. A custom gesture is then created using a range of sensor parameters taken from the three gesture recordings. This custom gesture becomes the template that will need to be matched when the user wishes to switch between partitions. When authentication is required to access a partition, the user will have the option to store a password during the creation of the custom gesture. This enables seamless switching between partitions in a secure manner.

The second component is a context switcher. Once a personal gesture pattern has been stored, the user can use the gesture to switch from one virtual partition to another. Each time the system recognizes a match with the stored gesture pattern, it automatically signals the inactive partition to transition from a lower power state such as the S3 Advanced Configuration and Power Interface Specification (ACPI) general state (relative to higher power consuming S0 general or global state) or C3 processor state (relative to higher power consuming C0 processor state).

The user can switch between partitions by repeating the customized gesture. As the active partition changes, the inactive partition moves from the S0 to S3 states. This provides an elegant user experience while improving power management on a mobile device.

The mobile device may include a gesture recorded that defines the custom gesture to be used for context shifting between partitions. And a custom gesture may be used to switch between partitions.

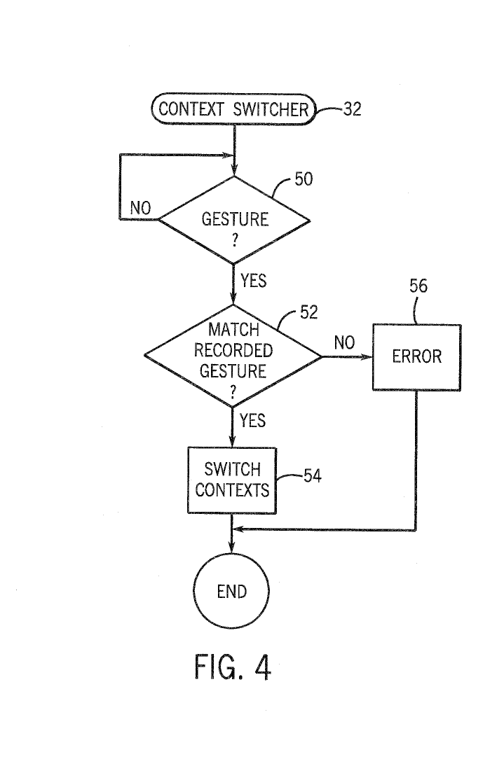

Referring to FIG. 4, a sequence 32 for implementing a context switch may be implemented in software, firmware and/or hardware. In software and firmware embodiments it may be implemented by computer executed instructions stored in one or more computer readable media such as non-transitory computer readable media including magnetic, optical or semiconductor storages. For example, the sequence may be implemented in program instructions stored in a storage 18 lower than the processor 12 itself as two examples.

The sequence 32 begins by recognizing a gesture as indicated at diamond 50. Once an input gesture is received, the gesture is compared to stored gestures that may be preprogrammed by the user or preprogrammed by default within the machine as indicated in diamond 52. If there is a match, then the context may be switched. Namely the system switches from one partition to another according to the instructions recorded together with the gesture, as indicated in diamond 54. Otherwise if there is no match with a prerecorded gesture at diamond 52, an error may be detected at block 56 and the flow ends.

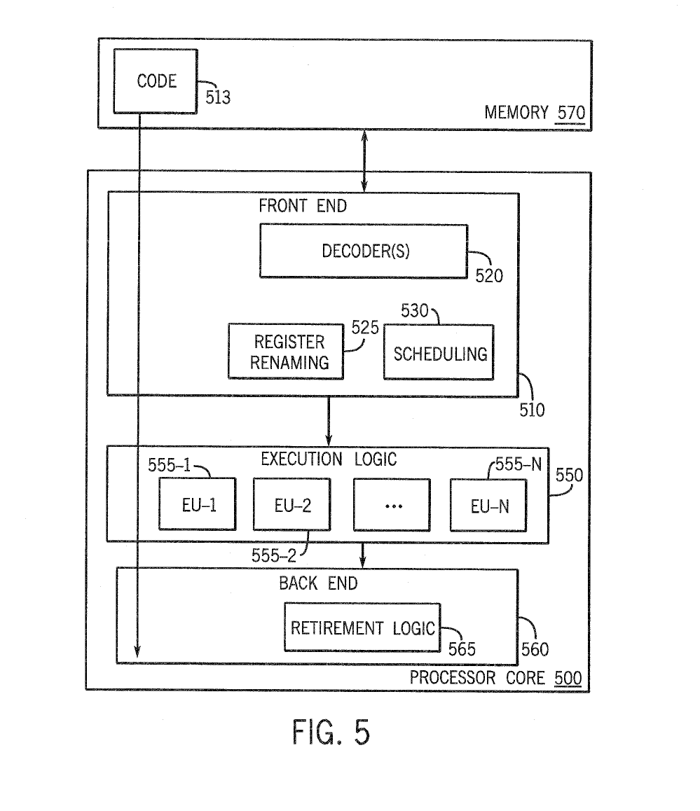

FIG. 5 illustrates a processor core 500 according to an embodiment. Processor core 500 may be the core for any type of processor, such as a micro-processor, an embedded processor, a digital signal processor (DSP), a network processor, or other device to execute code. Although only one processor core 500 is illustrated in FIG. 5, a processing element may alternatively include more than one of the processor core 500 illustrated in FIG. 5. Processor core 500 may be a single-threaded core or, for at least one embodiment, the processor core 500 may be multithreaded in that it may include more than one hardware thread context (or “logical processor”) per core.

FIG. 5 also illustrates a memory 570 coupled to the processor 500. The memory 570 may be any of a wide variety of memories (including various layers of memory hierarchy) as are known or otherwise available to those of skill in the art. The memory 570 may include one or more code instruction(s) 513 to be executed by the processor 500. The processor core 500 follows a program sequence of instructions indicated by the code 513. Each instruction enters a front end portion 510 and is processed by one or more decoders 520. The decoder may generate as its output a micro operation such as a fixed width micro operation in a predefined format, or may generate other instructions, microinstructions, or control signals, which reflect the original code instruction. The front end 510 also includes register renaming logic 525 and scheduling logic 530, which generally allocate resources and queue the operation corresponding to the convert instruction for execution.

The processor 500 is shown including execution logic 550 having a set of execution units 555-1 through 555-N. Some embodiments may include a number of execution units dedicated to specific functions or sets of functions. Other embodiments may include only one execution unit or one execution unit that can perform a particular function. The execution logic 550 performs the operations specified by code instructions.

After completion of execution of the operations specified by the code instructions, back end logic 560 retires the instructions of the code 513. In an embodiment, the processor core 500 allows out of order execution but requires in order retirement of instructions. Retirement logic 565 may take a variety of forms as known to those of skill in the art (e.g., re-order buffers or the like). In this manner, the processor core 500 is transformed during execution of the code 513, at least in terms of the output generated by the decoder, the hardware registers and tables utilized by the register renaming logic 525, and any registers (not shown) modified by the execution logic 550.

Although not illustrated in FIG. 5, a processing element may include other elements on chip with the processor core 500. For example, a processing element may include memory control logic along with the processor core 500. The processing element may include I/O control logic and/or may include I/O control logic integrated with memory control logic. The processing element may also include one or more caches.

The following clauses and/or examples pertain to further embodiments:

One example embodiment may be a computer readable medium including one or more instructions that when executed as a processor, configure the processor to perform a sequence comprising: detecting a gesture input to a processor based device, determining if the detected gesture matches a user-defined gesture pattern; and changing context from one partition to another partition in response to matching gesture detection. The medium may include instructions to perform a sequence including in response to determining a match between the detected gesture pattern and the user-defined gesture pattern, automatically changing the power state of one partition from a higher power consuming state to a lower power consuming state, and automatically changing the state of another, different partition from a lower to a higher power consuming state. The medium may further include instructions to switch between work and personal partitions in response to gesture detection. The medium may further include instructions to perform a sequence including detecting a gesture on a touch screen. The medium may further include instructions to implement a password requirement to change context. The medium may further include instructions to detect a gesture involving movement of a mobile processor based device. The medium may further include instructions to detect movement of said device using one of a gyroscope or accelerometer.

In another example embodiment a computer executed method comprising: detecting a gestural input to a processor based device, determining whether the gestural input matches a pre-stored gestural pattern; and changing partitions in response to gesture matching. The method may also include determining a match between the detected gesture and a stored gesture, automatically changing the power state of one partition from a higher power consuming state to a lower power consuming state and automatically changing the state of another, different partition from a lower to a higher power consuming state. The method may also include switching between work and personal partitions in response to gestured detection. The method may also include performing a sequence including detecting a gesture on a touch screen. The method may also include implementing a password requirement to change partitions.

Another example embodiment may be an apparatus comprising a processor to compare a detected gesture to a pre-store gesture and to change contact from one partition to another in response to gesture detection, and a memory coupled to said processor. The apparatus may include a motion detection device coupled to said processor to detect motion of said apparatus. The apparatus may include one of a gyroscope or accelerometer. The apparatus may also include a global positioning system to determine the location of the device. The apparatus may also include said processor to determine whether the device is in a predefined location before changing context. The apparatus may also include a touch screen, said processor to detect a gestural pattern of touch screen activations. The apparatus may also include said processor to detect swiping across said touch screen to change context. The apparatus may also include where one of said partitions is a work partition and the other is a personal partition.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one computer readable storage medium including one or more instructions that when executed as a processor, configure the processor to perform a sequence comprising:
detecting a gesture input to a processor based device;
determining if the detected gesture matches a user-defined gesture pattern; and
changing context from one partition to another partition in response to matching gesture detection.

2. The medium of claim 1 including instructions to perform a sequence including in response to determining a match between the detected gesture pattern and the user-defined gesture pattern, automatically changing the power state of one partition from a higher power consuming state to a lower power consuming state, and automatically changing the state of another, different partition from a lower to a higher power consuming state.

3. The medium of claim 1 further including instructions to switch between work and personal partitions in response to gesture detection.

4. The medium of claim 1 further including instructions to perform a sequence including detecting a gesture on a touch screen.

5. The medium of claim 1 further including instructions to implement a password requirement to change context.

6. The medium of claim 1 further including instructions to detect a gesture involving movement of a mobile processor based device.

7. The medium of claim 6 further including instructions to detect movement of said device using one of a gyroscope or accelerometer.

8. The medium of claim 6 further including instructions to detect waving of said processor based device

9. The medium of claim 1 including instructions to detect screen swiping as a trigger for changing context.

10. A computer executed method comprising:
detecting a gestural input to a processor based device;
determining whether the gestural input matches a pre-stored gestural pattern; and
changing partitions in response to gesture matching.

11. The method of claim 10 including in response to determining a match between the detected gesture and a stored gesture, automatically changing the power state of one partition from a higher power consuming state to a lower power consuming state and automatically changing the state of another, different partition from a lower to a higher power consuming state.

12. The method of claim 10 including switching between work and personal partitions in response to gestured detection.

13. The method of claim 10 including performing a sequence including detecting a gesture on a touch screen.

14. The method of claim 10 including implementing a password requirement to change partitions.

15. The method of claim 10 including detecting a gesture involving movement of a processor based device.

16. The method of claim 15 including detecting movement of said device using one of a gyroscope or accelerometer.

17. The method of claim 15 including detecting waving of said processor based device.

18. The method of claim 10 including detecting screen swiping as a trigger for changing partitions.

19. An apparatus comprising a processor to compare a detected gesture to a pre-store gesture and to change contact from one partition to another in response to gesture detection; and
a memory coupled to said processor.

20. The apparatus of claim 19 including a motion detection device coupled to said processor to detect motion of said apparatus.

21. The apparatus of claim 19 including one of a gyroscope or accelerometer.

22. The apparatus of claim 19 including a global positioning system to determine the location of the device.

23. The apparatus of claim 22 said processor to determine whether the device is in a predefined location before changing context.

24. The apparatus of claim 23 including a touch screen, said processor to detect a gestural pattern of touch screen activations.

25. The apparatus of claim 24 said processor to detect swiping across said touch screen to change context.

26. The apparatus of claim 19 including a camera coupled to said processor, said processor to analyze video to detect a gesture.

27. The apparatus of claim 19 said processor to transition the power state of one partition in response to gesture detection by decreasing power consumption and to increase the power consumption of another partition.

28. The apparatus of claim 19 said processor to require entry of a password to change partitions.

29. The apparatus of claim 19 including at least two virtual partitions.

30. The apparatus of claim 19 where one of said partitions is a work partition and the other is a personal partition.
